(19) United States
(12) Patent Application Publication
(10) Pub. No.: US 2005/0246353 A1
(43) Pub. Date: Nov. 3, 2005

(54) Automated transformation of unstructured data

(76) Inventors: Yoav Ezer, Jerusalem (IL); Saar Dickman, Kfar Vradim (IL); Eran Shir, Kfar Sava (IL); Guy Hachlili, Jerusalem (IL); Ilan Tayary, Jerusalem (IL); Guy Ruvio, Jerusalem (IL)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/838,534

(22) Filed: May 3, 2004

(51) Int. Cl. G06F 7/00

(52) U.S. Cl. 707/100

(57) ABSTRACT

A data processing method for automatically identifying the underlying syntaxes of unstructured data items, where unstructured data items are strings that include incomplete syntactical information but implicitly are characterized by a nontrivial syntax. The method comprises receiving input of unstructured data items into a processing machine memory; and recognizing the underlying syntaxes of the data items by the processing machine by applying pattern recognition techniques, wherein this step comprises identifying potential syntax components; and combining the components until the underlying syntaxes emerge.

### FIELD OF THE INVENTION

The present invention relates to data transformation, more specifically to automatically deducing the underlying syntax of a set of unstructured data and constructing an adapter for that syntax.

### BACKGROUND OF THE INVENTION

Today's enterprises are frequently faced with the task of converting unstructured data to a format that computing machines can work with. For example, an enterprise may want to access such data directly or to make it available in a format understood by another application.

Most current solutions deal with semi-structured data and not unstructured data. There are some patents dealing with data of that kind, including, for example, U.S. Pat. No. 5,826,258 by Junglee Corporation: “Method and apparatus for structuring the querying and interpretation of semistructured information”. The adding of ‘meta-data’ to existing documents is not a new idea, but the innovation detailed herein provides a method to extract data from documents.

There are also existing patents providing ways of extracting information from semistructured documents; for example, the U.S. Pat. No. 6,571,243 by Amazon: “Method and apparatus for creating extractors, field information objects and inheritance hierarchies in a framework for retrieving semistructured information”, details a way of extracting data from documents, but that method requires implementers to know the specifics of the data structure in advance, as it only provides ways of combining the extracted data into a single storage, and of allowing several different extractors to work on the same data (document), but not an automated way of retrieving generic information from the semistructured data. More specific ways of extracting data generic information exists; for example, U.S. Pat. No. 6,604,099: “Majority schema in semi-structured data”, provides a way to extract information from HTML files, based on the assumption that those files are to be visually represented—but also on the tags that exists in those documents. The innovation detailed herein doesn't require tags placed inside the data to work.

The term unstructured data as used herein refers to data strings that include incomplete syntactical information but implicitly are characterized by a nontrivial syntax. Put differently, unstructured data comprises content organized in a structure that, while understandable to a human being, is not understandable, or is less understandable, to a computing machine. In the context of the present invention the term “string” comprises all kinds of textual elements (like characters, digits, formatting sequences, tables, graphic elements supporting textual data, etc.).

To illustrate this, consider a table, the cells of which contain one or more instances of labeled data. For example a table of addresses, where each cell contains an address and the address comprises street, town, zip code, etc. If this table is implemented in plain ASCII text, there may be no information to indicate to a machine where the table starts or where the parts of the address start—whereas a human reading the form would perceive the structure immediately. If the table were implemented in HTML, the tags would tell the machine where the table and columns start—however they would not inform the machine about the internal structure of the addresses (street, town, etc.).

Another example of unstructured data is a form in rich text format (RTF). The data string comprising the form includes embedded codes that a computer can interpret as indicating the definition of table cells yet cannot determine the syntax of the elements stored in the cells.

Many electronically mediated business processes have a need for software adaptors that enable the creation of smooth interfaces between unstructured data from otherwise distinct and disjoint applications. The purpose of adapters is to translate data created by a certain application in a specific format into data which conforms to a different format and syntax, without inserting garbage data and without damaging the reliability of the data. The main task adapters fulfill is the identification of the syntactic and structural nature of the data. The steps necessary for fulfilling this task are:
1. clear and correct distinction between the various structure elements and between structure and content elements
2. creation of correct linkage between content elements and structure elements, which together identify self contained syntax elements such as fields, tables, free text, reports, etc.

An additional task is the task of identifying the semantic nature of data structures once they are identified.

The problem therefore, is to automatically create an adapter for a given stream of unstructured data, based on a corpus of samples from that stream.

From this corpus of data samples, referred to herein as data items, one would like to deduce the underlying data mapping and format logic. In addition, one would like to transfer this knowledge into a formulized application which will become the core of an adapter that specializes in the respective data format.

One would also like to enable dealing with multiple data structures simultaneously, automatically identifying the different formats and building the correct adapter for each syntax model, without having the multiple syntaxes suffer from cross interference. Once these problems are solved, the ability to transfer data which is considered unstructured into a structured form becomes feasible.

In addition, knowing the various syntaxes enables many other important business applications, such as identifying duplicate syntaxes and identifying deviations from a canonical syntax.

The problem outlined above has been tackled in prior art using numerous methodologies and technologies, which vary in their level of automation and generic applicability.

The first and most widespread prior art solution to the problem of creating an adapter and using it to transform unstructured to structured data is to manually program the adapter.

In this approach a programmer studies the structure to be formulized. After completely comprehending the data format, he then creates a program tailored specifically for this format. The resulting adapter is fed the defined input and transfers it into the desired output according to the set of rules that the programmer specified.

This methodology is rated relatively very high with regard to accuracy and efficiency of the resulting adapter, since it is pinpointed exactly and is completely human based.

However, it is also an extremely resource consuming approach, as each data type requires a separate design and programming effort. In addition, the type of resources used, it being a development project, are very expensive, as software designers as well as programmers are needed. Such an approach also suffers from drawbacks related to its being a bona fide programming project, such as the need for a serious QA stage for the code written, in addition to the QA required to check the accuracy of the data structure the initial analysis created. Due to its extensive resource consumption, this approach does not scale well when one moves from few syntax formats to hundreds or thousands.

A second, more advanced, prior art solution allows a user who lacks programming skills to create the core of the adapter. This approach can be outlined in the following manner:

A format generator, usually possessing a visual interface, is presented to the user. The user, in turn, builds a visual representation of the data structure to be analyzed using a set of predefined building blocks. The visual representation created by the user is transformed into a software adapter that implements the relationship between objects as defined in the visual representation.

While this methodology reduces the level of expertise needed in order to create an adapter, as well as the time cycles for creating an adapter, it does not come without a price. In order to allow for such a technology to work, one must go from the extremely high level of flexibility and adaptability a programmer potentially has to a much more rigid form, in which the user is restricted only to a certain set of predefined objects as well as predefined relationships. This handicap severely reduces the scope of applicability of this technology, which encompasses mainly relatively simple structures. In addition, this type of technology is still very intensive with regard to human labor. Projects become extremely hard even when involving only hundreds of different structures.

The third prior art solution, which somewhat resembles the previous one, and which on our scale is the most advanced solution, utilizes a learning by example mechanism. In this approach, a user goes over a sample of the data and identifies the correct data structures. Subsequently the system creates a script/application that implements the user's input to a generic adapter for the specified data structure. This is done usually through a rule system. However, it can also be done using a pattern recognition/stochastic learning algorithm

After a user has gone through the set of samples and marked the all the structural elements, the resulting data can be either implemented directly through a rule based system which translates the user's choices into parsing scripts or is used as a training set for a pattern recognition algorithm which has the task of inferring from the explicit structure defined on the samples the correct generic structure to which the samples belong.

This third approach, referred to as “learning by example” supercedes somewhat the previous technologies, since it requires even fewer trained personnel. However, it suffers from the same problems described above, since the work of creating an adapter remains labor intensive. In addition, since a learning algorithm is used, a quality assurance (QA) stage is required in order to fix unavoidable mistakes. While going a step further towards the goal of automation of the adapter creation process, “learning by example” technology is still far from this goal. The fact that a human processed training set is a must, as well as a careful QA stage, keeps this technology from reaching the target of rapid, automatic, integration.

While there are problems where explicit definition of the desired solution does not advance a long way towards reaching the optimal solution and the role of the learning or pattern recognition algorithm is extremely important, the case of analyzing unstructured data and creating an adapter is not of this type.

Pattern recognition algorithms require some human labor. Usually the labor is in the form of defining the problem, either explicitly (through a target function) or implicitly (through a set of known, human created solutions). There is no point in using a pattern recognition algorithm if the human labor required is of the same, or greater, order as the labor required to solve the problem manually. A pattern recognition algorithm is useful only if it is much easier to define the solution characteristics than to solve the problem manually. In the case of the problem set here, unstructured data, traditional pattern recognition algorithms require an amount of work on the order of the work needed to solve the problem manually, so there is no point in using them.

In fact, after a user has gone through the labor of manually structuring the provided samples, not much gap is left for the algorithm to bridge. Actually, in many situations it is easier to go the extra mile and define explicitly the logic of the data format either using a visual tool or by explicit programming, rather than go over all of the related samples and identifying their inherent structure.

In all of the prior art solutions, the human user takes the front seat, as all of them are labor intensive. Such solutions do not scale well when faced with multitudes of formats. In fact there are certain applications that are outright impossible for a solution that is less than fully automatic.

Only a technology that relegates the user to the back seat as supervisor can enable applications such as migration of thousands of report templates or truly adaptive, integration free, business-to-business.

It should be mentioned that the prior art described above assumes a single structure type is examined at a time, leaving the user the task of identifying the amount of data syntaxes (syntax enumeration) and distinguishing between samples of differing syntaxes (clustering). Leaving the syntax enumeration and clustering to humans creates a very high barrier when facing a large amount of varying syntaxes.

The invention described in this patent application can be seen as belonging to the family of stochastic learning technologies. However, it implements a new type of learning algorithm, which goes far beyond the current state of the art.

The present invention provides rapid and efficient categorization of the data items it is given to work on and accurate extraction of the underlying syntax models of each of the formats it is presented with.

The present invention provides the following innovations:
1. on the job training
2. optimal solution for multiple problems
3. combinatorial division and unification

Innovation 1—on the job training: Unlike traditional learning/pattern recognition algorithms, the proposed system alleviates the need for an explicit definition of the target function or for a training set.

While there are problems (such as the traveling salesman problem) where the explicit definition of the target function does not cost anything more once the problem has been stated, there are other problems when one cannot oblige a clearly defined target function (sometimes because one cannot be produced—for example, problems involving people where one cannot foresee their actions and needs in a complete form).

In addition, there are problems (like the problem of training a neural network to correctly cluster newsgroups articles) where the labor involved for creating a training set (in the newsgroup example, the mere provision of a subset of the articles over a certain time period, organized according to their originate grouping) is relatively small compared to the labor involved for solving the problem manually. (Again, in our example, the task of categorizing a training set is much easier than the task of categorizing the entire set of newsgroups articles, since each new article requires a separate, new consideration).

The problem of identifying the syntactic structure of data and creating a data transformation adapter is situated at the center of a different type of problem, the type for which traditional pattern recognition algorithms cannot be easily implemented. This is due to two reasons;
1. The only way to define the target function explicitly is to fully describe the characteristics of the solution, thus making the use of a learning algorithm redundant.
2. Where any two elements conform to the same syntax, once you have the syntax for the first element, by definition you have the syntax for the second element as well, again making the use of a learning algorithm redundant.

Thus only a learning algorithm that doesn't require the provision of an explicit target function or of human analyzed training examples can efficiently solve this problem. Until now, no algorithm has been proposed that can learn data structures without one of these two elements. In this aspect the present invention represents an innovative step beyond the current state of the art, with application for problems such as the data transformation problem, where, as mentioned, traditional pattern recognition algorithms cannot be easily implemented.

Innovation 2—optimal solution for multiple problems: Each version of a traditional optimization algorithm has a specific scope of problems for which it is optimal. In the celebrated No Free Lunch theorem proved by Wolpert and Macready (David H. Wolpert and William G. Macready, No Free Lunch Theorems for Optimization, 1, IEEE Transactions on Evolutionary Computation, 67, 1997, at http://citeseer.ni.nec.com/wolpert96no.html) it is shown rigorously that there is no single algorithm that can be most efficient when facing all kinds of optimization or pattern recognition problems. While this result is mathematically rigorous, one can gain insight into its essence without going into mathematical equations, if one observes that optimization, learning, and pattern recognition algorithms are all algorithms for solving problems where the space of solutions is so vast that no effective exhaustive algorithm can be devised.

Thus, algorithms pertaining to solve such problems always have certain stochastic/heuristic attributes that assume certain characteristics of the desired solution, so that there won't be a need to do an exhaustive search in the space of solutions. However, these assumptions, in order to have any effectiveness must not be generic, rather they must be specific to the problem the algorithm implementation tries to solve. Thus these assumptions contain information about the symmetries of the specific problem. Therefore, the more a certain implementation is optimized for a specific problem, the less it is adequate for problems that vary greatly from the first type of problem.

One can consider the space of optimization problems as an extremely complex space where for each point in this space, a separate solution space is attached, each with unique features.

Therefore another novel aspect of the proposed invention lies in the fact that whereas traditional algorithms are optimized for a confined area in the space of problems, the proposed invention creates a pattern recognition framework that embodies simultaneously very large segments of the problem space and enables the optimized convergence of distinct solutions to multiple problems simultaneously. This ability also greatly speeds convergence to correct data structures, as structure segments developed or identified during the course of finding a certain solution are transferred and diffused to other problem areas. Thus, the invention creates non-trivial links between otherwise distinct problems and data structures. The underlying fabric created enables the rapid simultaneous identification of multiple data structures.

Innovation 3—combinatorial division and unification: The proposed invention entails a hierarchy of more and more complex structure primitives. This hierarchy is emergent in the sense that the various elements encapsulating structural information in the data formats are created upon contact with the presented data structures and self-organize to build more and more sophisticated syntaxes. The term “presented data” here refers to the set of samples, which comprises underlying syntaxes that a human will identify. (This set, however, does not require any human labor before inserting it into the system.)

The method by which these sophisticated output elements are created guarantees that they have a potential meaningful role, thus reducing the creation problem to a combinatorics problem.

The primary novelty in this case is that the complex problem of identifying correct syntax models is first divided into multitudes of much simpler problems which are then stochastically solved and combined until they form the desired syntax hidden in the data.

The advantages of the present invention can be divided into applicative advantages and technological advantages.

The most important applicative advantage over current state of the art is the fact that for the first time a truly automatic solution to the problem of syntax identification, data transformation and adapter creation is introduced. This advantage is very important due to two aspects:

The first aspect is that automatically identifying and formulating data formats greatly reduces EAI project costs, making them much more cost effective with a much clearer return on investment.

The second aspect is that due to the automation of this tedious and cumbersome process, the task of creating tailored adapters become much more scalable, thus enabling abilities and applications that are otherwise out of reach. Very large legacy systems left to deteriorate due to the inability to create adapters for thousands and tens of thousands of data formats or even just to identify relationships between seemingly unrelated formats can, using the present invention, be connected to more advanced technologies in a consistent manner.

The technological advantage of the present invention is more profound and has much larger scope of applicability. As was stated in the previous section, the proposed invention is bound to create a new family of pattern recognition systems, including:
Systems that do not require training or explicit definition of a target function.
Systems that adapt to varying environments and can handle multiple environments simultaneously.
Systems that enable cooperation between solution segments of different problems while avoiding noise and interference between different solutions.

These advantages become very significant when applying the underlying technology to the scope of applications far greater than just EAI and data transformation.

In describing the advantages, one must not forget that utilizing the system for the task of creating adapters for multiple data formats provides the added bonus of creating a very efficient structural clustering mechanism that provides, without any further work, information regarding the variety of structures in the data and their quantity.

In certain applications this advantage becomes extremely significant, as the task of identifying with certainty the exact number of structures as well as connecting each element to its exact structure can become very resource consuming.

### BRIEF DESCRIPTION OF THE INVENTION

There is thus provided in accordance with a preferred embodiment of the present invention, a method for automatically identifying the underlying syntaxes of unstructured data items, where unstructured data items are strings that include incomplete syntactical information but implicitly are characterized by a nontrivial syntax, the method comprising:
receiving input of unstructured data items into a processing machine memory; and
recognizing the underlying syntaxes of the data items by the processing machine by applying pattern recognition techniques, wherein this step comprises:
identifying potential syntax components; and
combining the components until the underlying syntaxes emerge.

Furthermore, in accordance with another preferred embodiment of the present invention, combining the components is done stochastically.

Furthermore, in accordance with another preferred embodiment of the present invention, recognizing the underlying syntaxes of the data items comprises:
creating an initial pool of bots using deterministic heuristic methods, wherein a bot represents a potential element of a syntax;
creating an initial population of syntax models by choosing sets of bots from the pool of bots; and
applying combinatorial evolution algorithms to the initial population of syntax models to develop a syntax model for each data item.

Furthermore, in accordance with another preferred embodiment of the present invention, choosing of the sets of bots is done randomly.

Furthermore, in accordance with another preferred embodiment of the present invention, the step of creating an initial pool of bots using deterministic heuristic methods comprises:
applying a set of rules and templates to the data items to produce bots; and
combining the produced bots to create complex bots.

Furthermore, in accordance with another preferred embodiment of the present invention, the step of applying combinatorial evolution algorithms to the initial population of syntax models to develop a syntax model for each data item comprises:
evaluating a population of syntax models over a set of data items by applying a set of feedback rules, producing evaluation results, and possibly new bots;
if one or more bots are produced, adding the said one or more bots to the pool of bots;
applying a convergence test to the evaluation results, to produce convergence results and, if the convergence results are satisfactory, outputting a resultant syntax model;
applying, if the convergence results are unsatisfactory, a split test to the evaluation results;
splitting, if the split test requires it, the set of data items into two subsets and a syntax model population that is related to the set of data items into two subpopulations, and creating a new instance of the step of applying combinatorial evolution algorithms with one of the subsets and its corresponding subpopulation, while continuing to apply the combinatorial evolution algorithms to the second subset and corresponding subpopulation;
creating a population of candidate syntax models from the pool of bots, wherein each syntax model is composed of a set of bots; and
repeating the above steps until the convergence test results are satisfactory for all instances of the algorithm.

Furthermore, in accordance with another preferred embodiment of the present invention, satisfactory convergence results are determined by testing how close a current best solution is to a maxima and how close this maxima is to a global maxima.

Furthermore, in accordance with another preferred embodiment of the present invention, the step of creating a population of candidate syntax models from the pool of bots comprises:
copying top performing syntax models into a new population of syntax models;
creating new syntax models through recombination of two or more parent top performing syntax models;
creating new syntax models through structural manipulations of top performing syntax models which suffer a local fault in their structure by:
adding a bot if a consistent hole in coverage of a corresponding data item has been identified
deleting a bot from a syntax model if its deletion improves the evaluation results of said syntax model changing order and properties of individual bots comprising the structure; and
creating syntax models from random sets of bots.

Furthermore, in accordance with another preferred embodiment of the present invention, the step of evaluating a population of candidate syntax models over a corresponding set of data items comprises
applying a set of feedback meta-rules, each of which outputs an evaluation result for each of the syntax models over each of the data items;
creating an overall evaluation result for each of the syntax models; and
identifying fault points in top performing models, where each fault point serves, in the step of creating a population of candidate syntax models from the pool of bots, to indicate a bad bot to be removed from a syntax model or a hole in the coverage of a syntax model.

Furthermore, in accordance with another preferred embodiment of the present invention, the step of adding a new bot to the pool of bots comprises identifying bots which correlate well to one another, or have a new meaning when put together, and creating a new bot in the pool of bots.
identifying variant repetitions of a bot, or a set of bots, and using the variant repetition to create a new, repeating, bot, where such a repeating bot can appear one or more times in one or more data items.

Furthermore, in accordance with another preferred embodiment of the present invention, the step of adding a new bot to the pool of bots comprises identifying variant repetitions of a bot, or a set of bots, and using the variant repetition to create a new, repeating, bot, where such a repeating bot can appear one or more times in one or more data items.

Furthermore, in accordance with another preferred embodiment of the present invention, the convergence test comprises at least one of the following:
testing the level of uniformity of the evaluation results of top performing candidate syntax models;
testing the derivative of the evaluation results across evolution generations;
testing the difference between the syntax model with the highest evaluation results and the syntax model with the lowest evaluation results; and
testing the rate of addition of new syntax models to the top crop of the population across several generations.

Furthermore, in accordance with another preferred embodiment of the present invention, the step of applying, if the results of the convergence test are unsatisfactory, a split test to the results of the evaluation; comprises at least one of the following:
testing whether there is a dominant syntax model in the population of candidate syntax models that does not perform well on a subset of data items;
testing whether there are large variances in the average evaluation results of candidate syntax models over different, coexisting data items.

Furthermore, in accordance with another preferred embodiment of the present invention, the step of splitting comprises:
identifying a set of candidate syntax models, whose evaluation results are similar over a subset of data items and the corresponding subset of data items;
creating a new instance of the combinatorial evolution algorithms applied on the subpopulation and subset of data items; and
continuing the original instance of the combinatorial evolution algorithms with the remaining set of data items and subpopulation of candidate syntax models.

Furthermore, in accordance with another preferred embodiment of the present invention, the method further comprises:
creating a data processing adapter from a syntax model; and
converting, using the adapter, unstructured data items into structured output.

Furthermore, in accordance with another preferred embodiment of the present invention, the structured output is in a database format.

Furthermore, in accordance with another preferred embodiment of the present invention, the structured output is in XML format.

Furthermore, in accordance with another preferred embodiment of the present invention, the structured output is in a spreadsheet format.

Furthermore, in accordance with another preferred embodiment of the present invention, the structured output is in a comma separated value (CSV) format.

Furthermore, in accordance with another preferred embodiment of the present invention, the structured output is in a hierarchical format.

Furthermore, in accordance with another preferred embodiment of the present invention, the method further comprises identifying duplicate syntax models in data items that have the same underlying syntax as a set that the model is based on.

Furthermore, in accordance with another preferred embodiment of the present invention, the method further comprises identifying deviations in data items that have the same underlying syntax as a set that the model is based on.

Furthermore, in accordance with another preferred embodiment of the present invention, the method further comprises identifying levels of similarity in a set of syntax models.

Furthermore, in accordance with another preferred embodiment of the present invention, the method further comprises transforming data items from one visual representation to another.

Furthermore, in accordance with another preferred embodiment of the present invention, the method further comprises:
receiving a new data item;
matching a most suitable syntax model from a set of syntax models to the new data item.

Furthermore, in accordance with another preferred embodiment of the present invention, the method further comprises dividing a set of data items into a set of clusters based on a set of corresponding syntax models.

There is thus also provided in accordance with a preferred embodiment of the present invention, a data processing system for automatically identifying the underlying syntaxes of unstructured data items, where unstructured data items are strings that include incomplete syntactical information but implicitly are characterized by a nontrivial syntax, the system comprising a processor, a computer-readable medium operatively coupled to the processor and storing data, and a computer program executed by the processor from the medium and comprising:
module that receives input of unstructured data items into a processing machine memory; and
module that recognizes the underlying syntaxes of the data items by the processing machine by applying pattern recognition techniques, wherein this step comprises:
module that identifies potential syntax components; and
module that combines the components until the underlying syntaxes emerge.

Furthermore, in accordance with another preferred embodiment of the present invention, the module that combines the components does so stochastically.

Furthermore, in accordance with another preferred embodiment of the present invention, the module that recognizes the underlying syntaxes of the data items comprises:
module that creates an initial pool of bots using deterministic heuristic methods, wherein a bot represents a potential element of a syntax;
module that creates an initial population of syntax models by choosing sets of bots from the pool of bots; and
module that applies combinatorial evolution algorithms to the initial population of syntax models to develop a syntax model for each data item.

Furthermore, in accordance with another preferred embodiment of the present invention, the module that chooses of the sets of bots does so randomly.

Furthermore, in accordance with another preferred embodiment of the present invention, the module that creates an initial pool of bots does so using deterministic heuristic methods and comprises:
module that applies a set of rules and templates to the data items to produce bots; and
module that combines the produced bots to create complex bots.

Furthermore, in accordance with another preferred embodiment of the present invention, the module that applies combinatorial evolution algorithms to the initial population of syntax models to develop a syntax model for each data item comprises:
module that evaluates a population of syntax models over a set of data items by applying a set of feedback rules, producing evaluation results, and possibly new bots;
module that, if one or more bots are produced, adds the said one or more bots to the pool of bots;
module that applies a convergence test to the evaluation results, to produce convergence results and, if the convergence results are satisfactory, outputs a resultant syntax model;
module that applies, if the convergence results are unsatisfactory, a split test to the evaluation results;
module that splits, if the split test requires it, the set of data items into two subsets and a syntax model population that is related to the set of data items into two subpopulations, and creates a new instance of the step of applying combinatorial evolution algorithms with one of the subsets and its corresponding subpopulation, while continuing to apply the combinatorial evolution algorithms to the second subset and corresponding subpopulation;
module that creates a population of candidate syntax models from the pool of bots, wherein each syntax model is composed of a set of bots; and
module that repeats the above steps until the convergence test results are satisfactory for all instances of the algorithm.

Furthermore, in accordance with another preferred embodiment of the present invention, satisfactory convergence results are determined by a module that tests how close a current best solution is to a maxima and how close this maxima is to a global maxima.

Furthermore, in accordance with another preferred embodiment of the present invention, the module that creates a population of candidate syntax models from the pool of bots comprises:
module that copies top performing syntax models into a new population of syntax models;
module that creates new syntax models through recombination of two or more parent top performing syntax models;
module that creates new syntax models through structural manipulations of top performing syntax models which suffer a local fault in their structure by:
module that adds a bot if a consistent hole in coverage of a corresponding data item has been identified module that deletes a bot from a syntax model if its deletion improves the evaluation results of said syntax model module that changes order and properties of individual bots comprising the structure; and
module that creates syntax models from random sets of bots.

Furthermore, in accordance with another preferred embodiment of the present invention, the module that evaluates a population of candidate syntax models over a corresponding set of data items comprises
module that applies a set of feedback meta-rules, each of which outputs an evaluation result for each of the syntax models over each of the data items;
module that creates an overall evaluation result for each of the syntax models; and
module that identifies fault points in top performing models, where each fault point serves, in the module that creates a population of candidate syntax models from the pool of bots, to indicate a bad bot to be removed from a syntax model or a hole in the coverage of a syntax model.

Furthermore, in accordance with another preferred embodiment of the present invention, the module that adds a new bot to the pool of bots comprises a module that identifies bots which correlate well to one another, or have a new meaning when put together, and module that creates a new bot in the pool of bots.
identifying variant repetitions of a bot, or a set of bots, and using the variant repetition to create a new, repeating, bot, where such a repeating bot can appear one or more times in one or more data items.

Furthermore, in accordance with another preferred embodiment of the present invention, the module that adds a new bot to the pool of bots comprises a module that identifies variant repetitions of a bot, or a set of bots, and a module that uses the variant repetition to create a new, repeating, bot, where such a repeating bot can appear one or more times in one or more data items.

Furthermore, in accordance with another preferred embodiment of the present invention, the module that performs the convergence test comprises at least one of the following:
module that tests the level of uniformity of the evaluation results of top performing candidate syntax models;
module that tests the derivative of the evaluation results across evolution generations;
module that tests the difference between the syntax model with the highest evaluation results and the syntax model with the lowest evaluation results; and
module that tests the rate of addition of new syntax models to the top crop of the population across several generations.

Furthermore, in accordance with another preferred embodiment of the present invention, the module that applies, if the results of the convergence test are unsatisfactory, a split test to the results of the evaluation; comprises at least one of the following:
module that tests whether there is a dominant syntax model in the population of candidate syntax models that does not perform well on a subset of data items;
module that tests whether there are large variances in the average evaluation results of candidate syntax models over different, coexisting data items.

Furthermore, in accordance with another preferred embodiment of the present invention, the module that splits comprises:
module that identifies a set of candidate syntax models, whose evaluation results are similar over a subset of data items and the corresponding subset of data items;
module that creates a new instance of the combinatorial evolution algorithms applied on the subpopulation and subset of data items; and
module that continues the original instance of the combinatorial evolution algorithms with the remaining set of data items and subpopulation of candidate syntax models.

Furthermore, in accordance with another preferred embodiment of the present invention, the system further comprises:
module that creates a data processing adapter from a syntax model; and
module that converts, using the adapter, unstructured data items into structured output.

Furthermore, in accordance with another preferred embodiment of the present invention, the structured output is in a database format.

Furthermore, in accordance with another preferred embodiment of the present invention, the structured output is in XML format.

Furthermore, in accordance with another preferred embodiment of the present invention, the structured output is in a spreadsheet format.

Furthermore, in accordance with another preferred embodiment of the present invention, the structured output is in a comma separated value (CSV) format.

Furthermore, in accordance with another preferred embodiment of the present invention, the structured output is in a hierarchical format.

Furthermore, in accordance with another preferred embodiment of the present invention, the system further comprises a module that identifies duplicate syntax models in data items that have the same underlying syntax as a set that the model is based on.

Furthermore, in accordance with another preferred embodiment of the present invention, the system further comprises a module that identifies deviations in data items that have the same underlying syntax as a set that the model is based on.

Furthermore, in accordance with another preferred embodiment of the present invention, the system further comprises a module that identifies levels of similarity in a set of syntax models.

Furthermore, in accordance with another preferred embodiment of the present invention, the system further comprises a module that transforms data items from one visual representation to another.

Furthermore, in accordance with another preferred embodiment of the present invention, the system further comprises:
module that receives a new data item;
module that matches a most suitable syntax model from a set of syntax models to the new data item.

Furthermore, in accordance with another preferred embodiment of the present invention, the system further comprises module that divides a set of data items into a set of clusters based on a set of corresponding syntax models.

### BRIEF DESCRIPTION OF THE FIGURES

The invention is described herein, by way of example only, with reference to the accompanying Figures, in which like components are designated by like reference numerals.

FIG. 1 shows a diagram of the hardware and operating environment in conjunction with which embodiments of the invention may be practiced;

FIG. 2 is a flowchart for automatically deducing the syntactic structure of a set of unstructured data and constructing an adapter in accordance with a preferred embodiment of the present invention.

FIG. 3 is an example of unstructured data used as input for a preferred embodiment of the present invention.

FIG. 4 is an example of unstructured data with syntax and content highlighted after being analyzed in accordance with a preferred embodiment of the present invention.

FIG. 5 is a flowchart illustrating the bot creation stage of a preferred embodiment of the present invention.

FIG. 6 is a flowchart illustrating the combinatorial evolution stage of a preferred embodiment of the present invention.

### DETAILED DESCRIPTION OF THE INVENTION

The most direct use of the present invention is for enterprise application integration (EAI) although it can be applied to any application involving conversion of unstructured data to structured data.

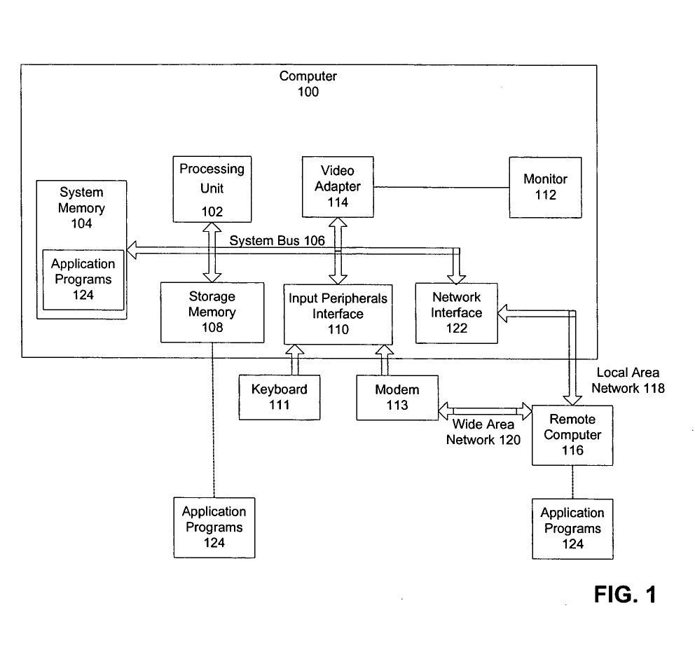

FIG. 1 illustrates a representative digital computer system that can be programmed to perform the method of this invention.

The exemplary hardware and operating environment of FIG. 1 for implementing the invention includes a general purpose computing device in the form of a computer 100, including a processing unit 102, a system memory 104, and a system bus 106 that operatively couples various system components include the system memory 104 to the processing unit 102. There may be only one or there may be more than one processing unit 102, such that the processor of computer 100 comprises a single central-processing unit (CPU), or a plurality of processing units, commonly referred to as a parallel processing environment. The computer 100 may be a conventional computer, a distributed computer, or any other type of computer; the invention is not so limited.

The system bus 106 may be any of several types of bus structures including a memory bus or memory controller, a peripheral bus, and a local bus using any of a variety of bus architectures. The system memory 104 may also be referred to as simply the memory, and includes read only memory (ROM) and random access memory (RAM). A basic input/output system (BIOS), containing the basic routines that help to transfer information between elements within the computer 100, such as during start-up, is stored in system memory 104. The computer 100 further includes storage memory 108, which can be a hard disk drive for reading from and writing to a hard disk, a magnetic disk drive for reading from or writing to a removable magnetic disk, and an optical disk drive for reading from or writing to a removable optical disk such as a CD ROM or other optical media.

Storage memory 108 is connected to the system bus 106 by the appropriate interface. Storage memory 108 provides nonvolatile storage of computer-readable instructions, data structures, program modules and other data for the computer 100. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored in the storage memory 108 hard disk or system memory 104, including an operating system, one or more application programs 124, other program modules, and program data.

A user may enter commands and information from input devices to the personal computer 100 via input peripherals interface 110. Such input devices can include a keyboard 111, a pointing device, a microphone, joystick, game pad, satellite dish, scanner, or the like. Input peripherals interface 110 is often a serial port interface that is coupled to system bus 106, but may be connected by other interfaces, such as a parallel port, game port, or a universal serial bus (USB). A monitor 112 or other type of display device is also connected to the system bus 106 via an interface, such as a video adapter 114. In addition to the monitor, computers typically include other peripheral output devices (not shown), such as speakers and printers.

The computer 100 may operate in a networked environment using logical connections to one or more remote computers, such as remote computer 116. These logical connections are achieved by a communication device coupled to or a part of the computer 100; the invention is not limited to a particular type of communications device. The remote computer 116 may be another computer, a server, a router, a network PC, a client, a peer device or other common network node, and typically includes many or all of the elements described above relative to the computer 100. The logical connections depicted in FIG. 1 include a local-area network (LAN) 118 and a wide-area network (WAN) 120. Such networking environments are commonplace in offices, enterprise-wide computer networks, intranets and the Internet.

When used in a LAN-networking environment, the computer 100 is connected to the local network 118 through a network interface or adapter 122, which is one type of communications device. When used in a WAN-networking environment, the computer 100 typically includes a modem 113, a type of communications device, or any other type of communications device for establishing communications over the wide area network 120, such as the Internet. The modem 113, which may be internal or external, is connected to the system bus via the input peripherals interface 110. In a networked environment, program modules depicted relative to the personal computer 100, or portions thereof, may be stored in the remote memory storage device. It is appreciated that the network connections shown are exemplary and other means of and communications devices for establishing a communications link between the computers may be used.

The hardware and operating environment in conjunction with which embodiments of the invention may be practiced has been described. The computer in conjunction with which embodiments of the invention may be practiced may be a conventional computer, a distributed computer, or any other type of computer; the invention is not so limited. Such a computer typically includes one or more processing units as its processor, and a computer-readable medium such as a memory. The computer may also include a communications device such as a network adapter or a modem, so that it is able to communicatively couple other computers.

Other digital computer system configurations can also be employed to perform the method of this invention, and to the extent that a particular system configuration is capable of performing the method of this invention, it is equivalent to the representative digital computer system of FIG. 1, and within the scope and spirit of this invention.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Once they are programmed to perform particular functions pursuant to instructions from program software that implements the method of this invention, such digital computer systems in effect become special-purpose computers particular to the method of this invention. The techniques necessary for this are well-known to those skilled in the art of computer systems.

The invention is directed to applying an evolutionary paradigm for automatically deducing the underlying syntax of a set of unstructured data items. A data item is a string. that does not include complete syntactical information but implicitly is characterized by a syntax that, while nontrivial, is not given to full machine interpretation. A set of data items can comprise data items sharing the same syntax or data items where some or all have unique syntaxes.

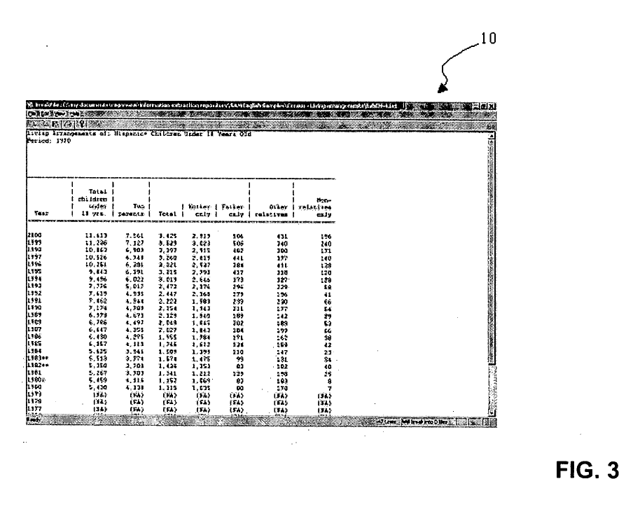

FIG. 3 shows a data item 10, in this case a page of a census report.

The present invention detects the underlying syntax in the unstructured data item and generates a model of the syntax. The model can be used for a number of useful purposes, such as:
creating an adapter that converts unstructured data items, which have the same underlying syntax, into a format that is machine-usable, for example to a database format or XML.
identifying existence of duplicate syntaxes
identifying deviations of elements from a canonical syntax

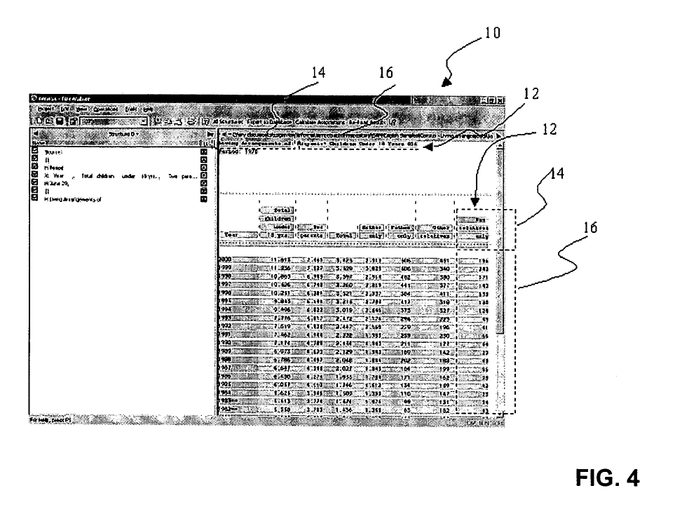

To do this, the invention creates a software representation, called a bot, for each potential element of the data syntax. A syntax model evolves using the pool of created bots until it accurately represents the syntax of an inherent structure in the data. FIG. 4 shows the data item 10 example of FIG. 3 after it has been analyzed by the present invention. Syntax model elements 12 have been detected. Each syntax element 12 comprises a data definition (header) 14 and content 16. A syntax element 12 can have a null data definition 12, however it cannot have null content 16 in all of the data items 10.

For each identified syntax model one can create a tailored adapter that takes as input unstructured data items 10 obeying the format of the learning sample set and providing as output a structured version of the data items (optionally manipulating some of the data elements).

The present invention is automatic in the sense that there is no need for a human created training set or a training stage. Rather, given a sample set of input data 20, the system, on its own, identifies the inherent structure. The main assumption underlying the system is that such structures exist, and that there are sufficient amounts of samples from each structure—where “sufficient” means that the relation between the size of the sample set and the complexity level of the underlying syntax is above the ambiguity threshold, a threshold above which no ambiguity in the distinction between the roles of the data item elements can occur.

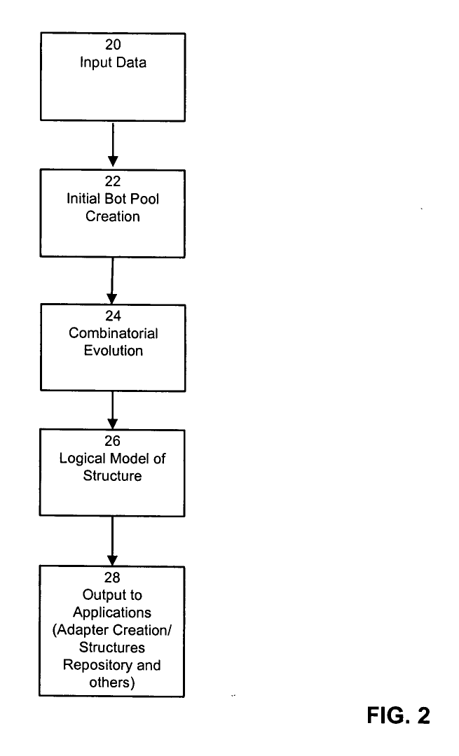

FIG. 2 is a general flowchart illustrating a method for automatically deducing the syntactic structure of a set of unstructured data and constructing an adapter in accordance with a preferred embodiment of the present invention. Input data 20 comprising data structures is used to create initial pool of bots 22. For example, the pairs of data definitions 14 and content 16 shown in FIG. 4 are represented in the present invention by bots.

Combinatorial evolution 24 is applied to the bots to produce a syntax model of the data structure 26. The syntax model serves as the basis for any of several output options 28, such as building an adapter to convert similar data items to structured data or creating a repository for storing the data syntaxes.

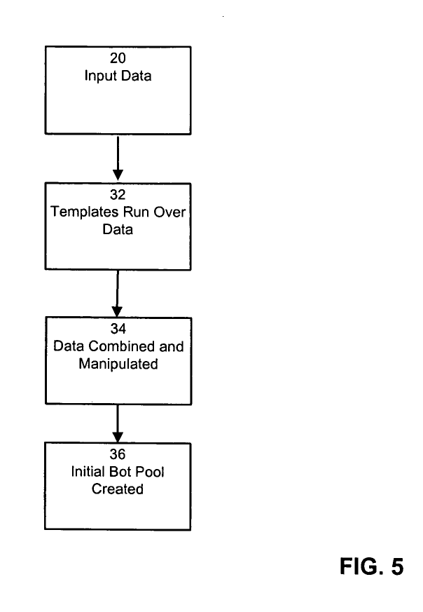

Details of initial bot pool creation 22, are shown in FIG. 5. Two groups of methods are applied. The first group consists of deterministic heuristic methods that analyze the given data set and create bots by running predefined bot templates 32 over the data set. The bots can relate to potential fields, tables, columns, frames and many other self-contained structural elements. Examples of such deterministic heuristic methods used in step 32:
1. Find a string A which abides regular expression template X and a string B which abides Y. This creates a bot that looks for data segments which start with A and end with B.
2. Find a recurring string which is underlined, and underneath it appears data in more than X percentage of the data items. This creates a bot that looks for vertical fields that are initiated by the string found, where the data appears below the underline and the field ends in a blank line.

There are many such methods, which identify tables, columns, single value fields, date fields etc.

The second group of bot creation methods assembles additional bots by performing combination and manipulation 34 on subsets of the group of bots created using the first, template-based, group of methods 32.

Examples of combination and manipulation 34 methods are:
1. Combining several correlated bots (which appear together frequently) into a larger, unified bot.
2. Creating, when a bot is identified as repeating in one or more data items, a repeating bot. This is important when the same structure appears in different quantities in different data items. For example, it might appear that two items, one comprised of six bots and one comprised of four bots, are not of the same structure. However, if both items contain the same two-bot combination that repeats (thrice and twice, respectively), then the two items can be identified as the same structure.

Each bot potentially relates to a segment of a syntax appearing somewhere in the sample set. All of the bots created in initial bot pool creation stage 22 are put into a single initial pool, even if originating from distinct syntaxes. In other words, even if the sample data item set comprises several syntaxes, all the bots created for all the structures are put into a common pool. Therefore if a bot can be applied to more than one syntax, it is available to each such syntax.

It will be noted that both stages 22 and 24 result in bot creation: In initial bot creation stage 22, bots are created using deterministic heuristics to study statistics of appearance of potential structural elements in the sample set, followed by combination and manipulation. In combinatorial evolution stage 24 more bots are created in a stochastic, non-deterministic manner. However, in stage 24 the creation of new bots is a byproduct of the process, while in stage 22 the bot creation is the essence of the stage. New bots created in stage 24 are based on bots already created in stage 22 and represent combinations of bots from the bot pool that other syntaxes (other than the syntax, during the creation of which, the bots were formed) may find useful.

Combinatorial evolution stage 24 improves, grows and fine tunes dominant syntax models by adapting the dynamic properties of its composing bots to its niche. The syntax's niche is identified by the characteristics of the data elements. (This stage can optionally be preceded by a step where inapplicable bots are removed from the niche—although retained in the bot pool for possible use in other niches.)

The uniqueness of this approach lies in the fact that, unlike the real world, combinatorial evolution 24 transcends the Darwinian paradigm of evolving better agents by random mutations and fitness selection. Combinatorial evolution allows large collective adaptive changes compatible with/required by the global features of the problem space. In this way, one avoids the stagnation of bots evolution in the local minima. It is like reducing the time evolution scale from millions of years to days by allowing free exchange of entire limbs and organs between individuals belonging to different species but acting in similar conditions. If you are a mouse and want to become a bat, instead of waiting to evolve the wings, you can just try borrowing them from a neighboring eagle. As such, covering of the problem space is much more efficient than covering of genetic niches in biology. Here, “providence” does exist: the system designer. Various regions in the problem space will be inhabited by different ecologies.

The combinatorial evolution phase 24 starts with creating a population of candidate model syntaxes. In the first iteration, the models are assembled by randomly combining correlated bots from the bot pool. Following the feedback mechanism, where each model gets a quality assessment value, several evolution-based operators create the population 50:
a. copying the top performing syntax models into the new population;
b. creating new syntax models through recombination of two or more parent top-performing syntax models; the probability of being a parent being proportional to the relative level of success of the model;
c. creating new syntax models through structural manipulations of top performing syntax models; and
d. creating syntax models from random sets of bots.

The feedback mechanism drives evolution and cooperation processes and determines selection and adaptation in the system, and is thus extremely important. Implicit feedback measures help score different bots and drive adaptation.

In the design of the feedback mechanism lies the great novelty of the current invention. Usually in evolutionary and other learning algorithms, the feedback is defined using a target function or a human-made training set. However, for the task of identifying syntaxes in data items no such effort is needed. This is due to the fact that while data structures may vary tremendously in format and may contain very different elements, still there are certain meta-rules that all structure models must abide by. In addition, each bot type (be it data field, table or other structure element type), has specific meta-rules that control all of its appearances, even if they spread over completely differing structures.

This set of meta-rules is on the one hand extremely generic, but on the other hand forces the evolution towards tailored complex bots, which are extremely accurate. The existence of these meta-rules might not be apparent at first glance, however the fact is that all of the syntaxes we aim to analyze were created to be used and understood by humans or computers. In the case they were created to be used by computers, obviously a rigid set of rules must be used, given the fact that computers are very rigid in their structuring demands. However, the important point is that structures that were created to be used by humans must also abide by very rigid rules, because human beings have certain ways in which they comprehend data, certain unspoken agreements which are embedded so strongly into our way of thinking that we just see them as natural and irreplaceable, and thus do not consider them at all. The identification of these underlying rules of how people perceive structured data, such as reports, documents etc. allows us to provide a set of meta-rules which are used in the feedback process of the evolution, without the need for specific human labor in each case.

The following are some examples of feedback meta-rules (expressed in human terminology):
1. Reports do not contain large irrelevant areas. Thus, a good syntax model covers a high percentage of the data items' scope.
2. A bot which covers more data is better, as long as it doesn't misinterpret syntax information as data.
3. Several columns that are identical in their characteristics and are adjacent are better interpreted as tables.
4. If two table representation bots cover the same area, one a column type bot and the other a multiplication table type (one which has headers both on the top and on the side), and the side headers always appear, it is better to interpret the data as a multiplication table.
5. Tables usually have headers which define the meaning of the data in the outer parts of the table
6. It is usually better to have a more elaborate, detailed structure than a more abstract, general one.
7. There is a distinction in the functions of the horizontal and the vertical dimension. While data items of the same structure usually do not differ in their horizontal offset (i.e., a field is usually situated in the same columns, and the horizontal size of a structure is the same) they may vary in their vertical size (a table may have a varying number of records.).

The specific meta-rules used can vary depending on the application.

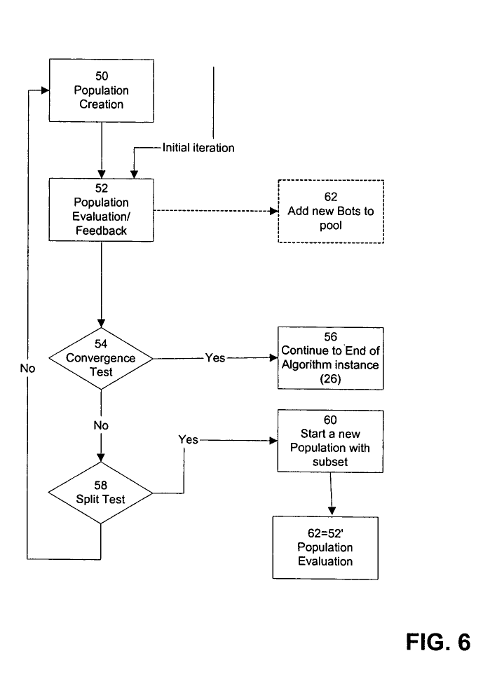

FIG. 6 illustrates the details of combinatorial evolution 24. Population creation 50 starts with the initial bot pool created in stage 22. Starting with the second iteration, population creation 50 comprises applying several operations to the previous population:
a. copying the top performing syntax models into the new population;
b. creating new syntax models through recombination of two or more parent top performing syntax models, the probability of being a parent being proportional to the relative level of success of the model;
c. creating new syntax models through structural manipulations of top performing syntax models which suffer a local fault in their structure by: Adding a bot if a consistent hole in coverage has been identified Deleting an offending bot when its deletion will cause the evaluation result of the syntax to rise Changing order and properties of individual bots comprising the structure; and,
d. creating syntax models from random sets of bots. These operations create the new population to be evaluated in step 52.

In population evaluation/feedback stage 52, bots are scored and checked for how they fit to data according to meta rules. The detailed steps comprising stage 52 are:
a. applying the set of feedback meta-rules, each of which outputs an evaluation result for each of the syntax models over each of the data items;
b. creating an overall evaluation result for each of the syntax models; and
c. identifying fault points in otherwise well performing models, such a fault points serving, in the population creation stage, to indicate a bad bot to remove from a model or a hole in an otherwise successful model to fill with a bot from the pool.

If, during stage 52, a new bot is created, which can happen for example, if the system identifies a strong correlation between two or more elementary bots, then the bot is added 62 to the bot pool so that it is available to other data structures.

Convergence test 54 checks whether one of the convergence criteria has been fulfilled. The convergence criteria check entities that signal whether a maximum of the process has been reached. Examples of such entities are the derivative of the evaluation results over evolution generations, the level of uniformity of the bots in the population, and the amount of new bots that are considered acceptable. The convergence test then checks whether the algorithm has reached a maxima in the space of potential syntaxes and the probability that this maxima is a global one.

If convergence is found to be satisfactory, the process continues 56 to structural modeling 26.

If not, then a split test 58 is performed: data items are tested to determine whether they should be split into groups to find possible multiple structures. The split test looks for situations where a syntax model becomes dominant, but is not relevant to the entire set of data items, or where there are large variances between the average success of a syntax over the entire set of date items 10 and its detailed success over specific data items 10. (If it is known that there is only one data structure, this test can be skipped and the system goes back to population creation 30.)

If the split test is required (i.e., system has more than one data structure), and if the result of the test is that the data is split, then start a new population 60 with a subset of the data items and their related structure bots. With the new population, repeat the process (create a new instance), starting with evaluation stage 62′ (which is equivalent to stage 52), etc.

Once convergence test 54 is passed for all instances, the system moves on to structure modeling 26. In structure modeling the resulting structure bot is used as the basis for modeling the structure, so that it can be used in various forms in the future.

Once the model is established it serves as the base for useful application of similar unstructured data. For example, the model can serve as the basis for adapters to convert the unstructured data to other, machine-understandable formats, such as:
proprietary
spreadsheet
hierarchical, such as XML (extendable markup language)
Comma separated value (CSV)
database

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the scope of the invention.

1. A data processing method for automatically identifying the underlying syntaxes of unstructured data items, where unstructured data items are strings that include incomplete syntactical information but implicitly are characterized by a nontrivial syntax, the method comprising:
receiving input of unstructured data items into a processing machine memory; and
recognizing the underlying syntaxes of the data items by the processing machine by applying pattern recognition techniques, wherein this step comprises:
identifying potential syntax components; and
combining the components until the underlying syntaxes emerge.

2. The method of claim 1 wherein combining the components is done stochastically.

3. The method of claim 1, wherein recognizing the underlying syntaxes of the data items comprises:
creating an initial pool of bots using deterministic heuristic methods, wherein a bot represents a potential element of a syntax;
creating an initial population of syntax models by choosing sets of bots from the pool of bots; and
applying combinatorial evolution algorithms to the initial population of syntax models to develop a syntax model for each data item.

4. The method of claim 3, wherein choosing of the sets of bots is done randomly.

5. The method of claim 3, wherein the step of creating an initial pool of bots using deterministic heuristic methods comprises:
applying a set of rules and templates to the data items to produce bots; and
combining the produced bots to create complex bots.

6. The method of claim 3 wherein the step of applying combinatorial evolution algorithms to the initial population of syntax models to develop a syntax model for each data item comprises:
evaluating a population of syntax models over a set of data items by applying a set of feedback rules, producing evaluation results, and possibly new bots;
if one or more bots are produced, adding the said one or more bots to the pool of bots;
applying a convergence test to the evaluation results, to produce convergence results and, if the convergence results are satisfactory, outputting a resultant syntax model;
applying, if the convergence results are unsatisfactory, a split test to the evaluation results;
splitting, if the split test requires it, the set of data items into two subsets and a syntax model population that is related to the set of data items into two subpopulations, and creating a new instance of the step of applying combinatorial evolution algorithms with one of the subsets and its corresponding subpopulation, while continuing to apply the combinatorial evolution algorithms to the second subset and corresponding subpopulation;
creating a population of candidate syntax models from the pool of bots, wherein each syntax model is composed of a set of bots; and
repeating the above steps until the convergence test results are satisfactory for all instances of the algorithm.

7. The method of claim 6, wherein satisfactory convergence results are determined by testing how close a current best solution is to a maxima and how close this maxima is to a global maxima.

8. The method of claim 6, wherein the step of creating a population of candidate syntax models from the pool of bots comprises:
copying top performing syntax models into a new population of syntax models;
creating new syntax models through recombination of two or more parent top performing syntax models;
creating new syntax models through structural manipulations of top performing syntax models which suffer a local fault in their structure by:
adding a bot if a consistent hole in coverage of a corresponding data item has been identified deleting a bot from a syntax model if its deletion improves the evaluation results of said syntax model changing order and properties of individual bots comprising the structure; and
creating syntax models from random sets of bots.

9. The method of claim 6, wherein the step of evaluating a population of candidate syntax models over a corresponding set of data items comprises
applying a set of feedback meta-rules, each of which outputs an evaluation result for each of the syntax models over each of the data items;
creating an overall evaluation result for each of the syntax models; and
identifying fault points in top performing models, where each fault point serves, in the step of creating a population of candidate syntax models from the pool of bots, to indicate a bad bot to be removed from a syntax model or a hole in the coverage of a syntax model.

10. The method of claim 6, wherein the step of adding a new bot to the pool of bots comprises identifying bots which correlate well to one another, or have a new meaning when put together, and creating a new bot in the pool of bots.
identifying variant repetitions of a bot, or a set of bots, and using the variant repetition to create a new, repeating, bot, where such a repeating bot can appear one or more times in one or more data items.

11. The method of claim 6, wherein the step of adding a new bot to the pool of bots comprises identifying variant repetitions of a bot, or a set of bots, and using the variant repetition to create a new, repeating, bot, where such a repeating bot can appear one or more times in one or more data items.

12. The method of claim 6, wherein the convergence test comprises at least one of the following:
testing the level of uniformity of the evaluation results of top performing candidate syntax models;
testing the derivative of the evaluation results across evolution generations;
testing the difference between the syntax model with the highest evaluation results and the syntax model with the lowest evaluation results; and
testing the rate of addition of new syntax models to the top crop of the population across several generations.

13. The method of claim 6, wherein the step of applying, if the results of the convergence test are unsatisfactory, a split test to the results of the evaluation; comprises at least one of the following:
testing whether there is a dominant syntax model in the population of candidate syntax models that does not perform well on a subset of data items;
testing whether there are large variances in the average evaluation results of candidate syntax models over different, coexisting data items.

14. The method of claim 6, wherein the step of splitting comprises:
identifying a set of candidate syntax models, whose evaluation results are similar over a subset of data items and the corresponding subset of data items;
creating a new instance of the combinatorial evolution algorithms applied on the subpopulation and subset of data items; and
continuing the original instance of the combinatorial evolution algorithms with the remaining set of data items and subpopulation of candidate syntax models.

15. The method of claim 3 further comprising:
creating a data processing adapter from a syntax model; and
converting, using the adapter, unstructured data items into structured output.

16. The method of claim 15 wherein the structured output is in a database format.

17. The method of claim 15 wherein the structured output is in XML format.

18. The method of claim 15 wherein the structured output is in a spreadsheet format.

19. The method of claim 15 wherein the structured output is in a comma separated value (CSV) format.

20. The method of claim 15 wherein the structured output is in a hierarchical format.

21. The method of claim 3 further comprising identifying duplicate syntax models in data items that have the same underlying syntax as a set that the model is based on.

22. The method of claim 3 further comprising identifying deviations in data items that have the same underlying syntax as a set that the model is based on.

23. The method of claim 3 further comprising identifying levels of similarity in a set of syntax models.

24. The method of claim 3 further comprising transforming data items from one visual representation to another.

25. The method of claim 3 further comprising:
receiving a new data item;
matching a most suitable syntax model from a set of syntax models to the new data item.

26. The method of claim 3 further comprising dividing a set of data items into a set of clusters based on a set of corresponding syntax models.

27. A data processing system for automatically identifying underlying syntaxes of unstructured data items, where unstructured data items are strings that include incomplete syntactical information but implicitly are characterized by a nontrivial syntax, the system comprising a processor, a computer-readable medium operatively coupled to the processor and storing data, and a computer program executed by the processor from the medium and comprising:
module that receives input of unstructured data items into a processing machine memory; and
module that recognizes the underlying syntaxes of the data items by the processing machine by applying pattern recognition techniques, wherein this step comprises:
module that identifies potential syntax components; and
module that combines the components until the underlying syntaxes emerge.

28. The system of claim 27 wherein the module that combines the components does so stochastically.

29. The system of claim 27, wherein the module that recognizes the underlying syntaxes of the data items comprises:
module that creates an initial pool of bots using deterministic heuristic methods, wherein a bot represents a potential element of a syntax;
module that creates an initial population of syntax models by choosing sets of bots from the pool of bots; and
module that applies combinatorial evolution algorithms to the initial population of syntax models to develop a syntax model for each data item.

30. The system of claim 29, wherein the module that chooses of the sets of bots does so randomly.

31. The system of claim 29, wherein the module that creates an initial pool of bots does so using deterministic heuristic methods and comprises:
module that applies a set of rules and templates to the data items to produce bots; and
module that combines the produced bots to create complex bots.

32. The system of claim 29 wherein the module that applies combinatorial evolution algorithms to the initial population of syntax models to develop a syntax model for each data item comprises:
module that evaluates a population of syntax models over a set of data items by applying a set of feedback rules, producing evaluation results, and possibly new bots;
module that, if one or more bots are produced, adds the said one or more bots to the pool of bots;
module that applies a convergence test to the evaluation results, to produce convergence results and, if the convergence results are satisfactory, outputs a resultant syntax model;
module that applies, if the convergence results are unsatisfactory, a split test to the evaluation results;
module that splits, if the split test requires it, the set of data items into two subsets and a syntax model population that is related to the set of data items into two subpopulations, and creates a new instance of the step of applying combinatorial evolution algorithms with one of the subsets and its corresponding subpopulation, while continuing to apply the combinatorial evolution algorithms to the second subset and corresponding subpopulation;
module that creates a population of candidate syntax models from the pool of bots, wherein each syntax model is composed of a set of bots; and
module that repeats the above steps until the convergence test results are satisfactory for all instances of the algorithm.

33. The system of claim 32, wherein satisfactory convergence results are determined by a module that tests how close a current best solution is to a maxima and how close this maxima is to a global maxima.

34. The system of claim 32, wherein the module that creates a population of candidate syntax models from the pool of bots comprises:
module that copies top performing syntax models into a new population of syntax models;
module that creates new syntax models through recombination of two or more parent top performing syntax models;
module that creates new syntax models through structural manipulations of top performing syntax models which suffer a local fault in their structure by:
module that adds a bot if a consistent hole in coverage of a corresponding data item has been identified module that deletes a bot from a syntax model if its deletion improves the evaluation results of said syntax model module that changes order and properties of individual bots comprising the structure; and
module that creates syntax models from random sets of bots.

35. The system of claim 32, wherein the module that evaluates a population of candidate syntax models over a corresponding set of data items comprises
module that applies a set of feedback meta-rules, each of which outputs an evaluation result for each of the syntax models over each of the data items;
module that creates an overall evaluation result for each of the syntax models; and
module that identifies fault points in top performing models, where each fault point serves, in the module that creates a population of candidate syntax models from the pool of bots, to indicate a bad bot to be removed from a syntax model or a hole in the coverage of a syntax model.

36. The system of claim 32, wherein the module that adds a new bot to the pool of bots comprises a module that identifies bots which correlate well to one another, or have a new meaning when put together, and module that creates a new bot in the pool of bots.
identifying variant repetitions of a bot, or a set of bots, and using the variant repetition to create a new, repeating, bot, where such a repeating bot can appear one or more times in one or more data items.

37. The system of claim 32, wherein the module that adds a new bot to the pool of bots comprises a module that identifies variant repetitions of a bot, or a set of bots, and a module that uses the variant repetition to create a new, repeating, bot, where such a repeating bot can appear one or more times in one or more data items.

38. The system of claim 32, wherein the module that performs the convergence test comprises at least one of the following:
module that tests the level of uniformity of the evaluation results of top performing candidate syntax models;
module that tests the derivative of the evaluation results across evolution generations;
module that tests the difference between the syntax model with the highest evaluation results and the syntax model with the lowest evaluation results; and
module that tests the rate of addition of new syntax models to the top crop of the population across several generations.

39. The system of claim 32, wherein the module that applies, if the results of the convergence test are unsatisfactory, a split test to the results of the evaluation; comprises at least one of the following:
module that tests whether there is a dominant syntax model in the population of candidate syntax models that does not perform well on a subset of data items;
module that tests whether there are large variances in the average evaluation results of candidate syntax models over different, coexisting data items.

40. The system of claim 32, wherein the module that splits comprises:
module that identifies a set of candidate syntax models, whose evaluation results are similar over a subset of data items and the corresponding subset of data items;
module that creates a new instance of the combinatorial evolution algorithms applied on the subpopulation and subset of data items; and
module that continues the original instance of the combinatorial evolution algorithms with the remaining set of data items and subpopulation of candidate syntax models.

41. The system of claim 32 further comprising:
module that creates a data processing adapter from a syntax model; and
module that converts, using the adapter, unstructured data items into structured output.

42. The system of claim 41 wherein the structured output is in a database format.

43. The system of claim 41 wherein the structured output is in XML format.

44. The system of claim 41 wherein the structured output is in a spreadsheet format.

45. The system of claim 41 wherein the structured output is in a comma separated value (CSV) format.

46. The system of claim 41 wherein the structured output is in a hierarchical format.

47. The system of claim 29 further comprising a module that identifies duplicate syntax models in data items that have the same underlying syntax as a set that the model is based on.

48. The system of claim 29 further comprising a module that identifies deviations in data items that have the same underlying syntax as a set that the model is based on.

49. The system of claim 29 further comprising a module that identifies levels of similarity in a set of syntax models.

50. The system of claim 29 further comprising a module that transforms data items from one visual representation to another.

51. The system of claim 29 further comprising:
module that receives a new data item;
module that matches a most suitable syntax model from a set of syntax models to the new data item.

52. The system of claim 29 further comprising module that divides a set of data items into a set of clusters based on a set of corresponding syntax models.
